(19) United States
(12) Patent Application Publication
(10) Pub. No.: US 2003/0009890 A1
(43) Pub. Date: Jan. 16, 2003

(54) Machine hand wheel

(75) Inventor: Lu-Hsiung Chang, Feng-Yuan City (TW)

Correspondence Address: LOWE HAUPTMAN GILMAN, & BERNER, LLP, Suite 310, 1700 Diagonal Road, Alexandria, VA, 22314, US

(73) Assignee: Cyclematic Machinery Co., Ltd.

(21) Appl. No.: 09/902,571

(22) Filed: Jul. 12, 2001

(51) Int. Cl. G01B 21/00

(52) U.S. Cl. 33/1 PT

(57) ABSTRACT

A hand wheel includes a hollow support base, an encoding device, a coupling shaft, an indicia member, a friction coupling unit, and a wheel member. The encoding device is disposed in a receiving space of the support base, has a seat portion and a rotary spindle, and generates an electrical signal output that corresponds to detected rotation of the spindle relative to the seat portion. The coupling shaft is connected to the spindle. The indicia member is sleeved on the coupling shaft for indicating angular rotation of the coupling shaft relative to the support base. The friction coupling unit permits co-rotation of the indicia member with the coupling shaft and forced rotation of the indicia member relative to the coupling shaft. The wheel member is operable for driving rotation of the coupling shaft.

### BACKGROUND OF THE INVENTION

1. Field of the Invention

The invention relates to a hand wheel for a machine, more particularly to a hand wheel suitable for a learning-type machine, such as a lathe.

2. Description of the Related Art

Referring to FIG. 1, a conventional lathe 1 is shown to comprise a plane stock 101, a headstock 102 disposed on a left end side of the plane stock 101, a tail stock 103 disposed on a right end side of the plane stock 101, a cutter seat 104 disposed movably on an upper side of the plane stock 101, and two hand wheels 105 disposed on a side portion of the cutter seat 104. The cutter seat 104 is movable slidably in a horizontal direction relative to the plane stock 101. Advancing and retreating movements of the cutter seat 104 are controlled with accuracy by rotating and adjusting the hand wheels 105, thereby cutting a work piece into the desired specification. However, because the hand wheels 105 have to be manually controlled and adjusted so as to obtain a number of work pieces having a consistent specification, long production hours and waste of manpower generally result.

### SUMMARY OF THE INVENTION

Therefore, the main object of the present invention is to provide a hand wheel suitable for use in a learning-type machine to overcome the aforementioned drawbacks of the prior art.

Accordingly, a hand wheel of this invention comprises a hollow support base, an encoding device, a coupling shaft, an indicia member, a friction coupling unit, and a wheel member. The hollow support base confines a receiving space with an open end. The encoding device is disposed in the receiving space, has a seat portion and a rotary spindle, and generates an electrical signal output that corresponds to detected rotation of the spindle relative to the seat portion. The seat portion is mounted to the support base. The rotary spindle is mounted rotatably on and extends from the seat portion toward the open end of the receiving space. The coupling shaft has a first end and an opposite second end. The first end is connected to the spindle such that the spindle is co-rotatable with the coupling shaft. The opposite second end extends outwardly from the open end of the receiving space. The indicia member is sleeved on the coupling shaft between the first and second ends for indicating angular rotation of the coupling shaft relative to the support base. The friction coupling unit is disposed between the coupling shaft and the indicia member to permit co-rotation of the indicia member with the coupling shaft and to permit forced rotation of the indicia member relative to the coupling shaft. The wheel member has a hub portion connected to the second end of the coupling shaft, and is operable for driving rotation of the coupling shaft.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view illustrating a conventional lathe;

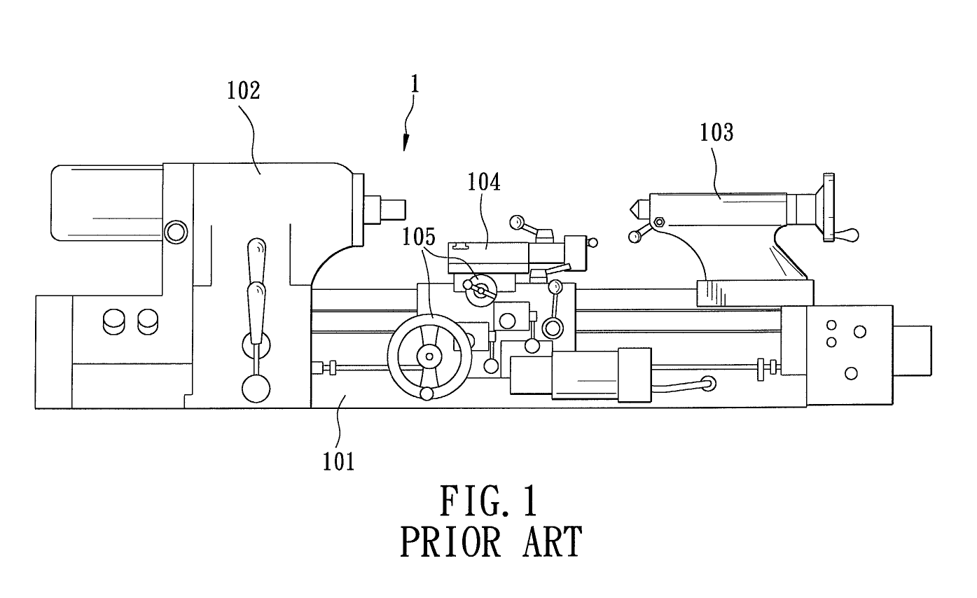

FIG. 2 is a schematic view illustrating a learning type lathe that incorporates the first preferred embodiment of a hand wheel according to the present invention;

FIG. 3 is a partly sectional schematic view of the first preferred embodiment of the hand wheel of the present invention; and

FIG. 4 is a partly sectional schematic view of the second preferred embodiment of a hand wheel according to the present invention.

### DETAILED DESCRIPTION OF THE PREFERRED EMBODIMENTS

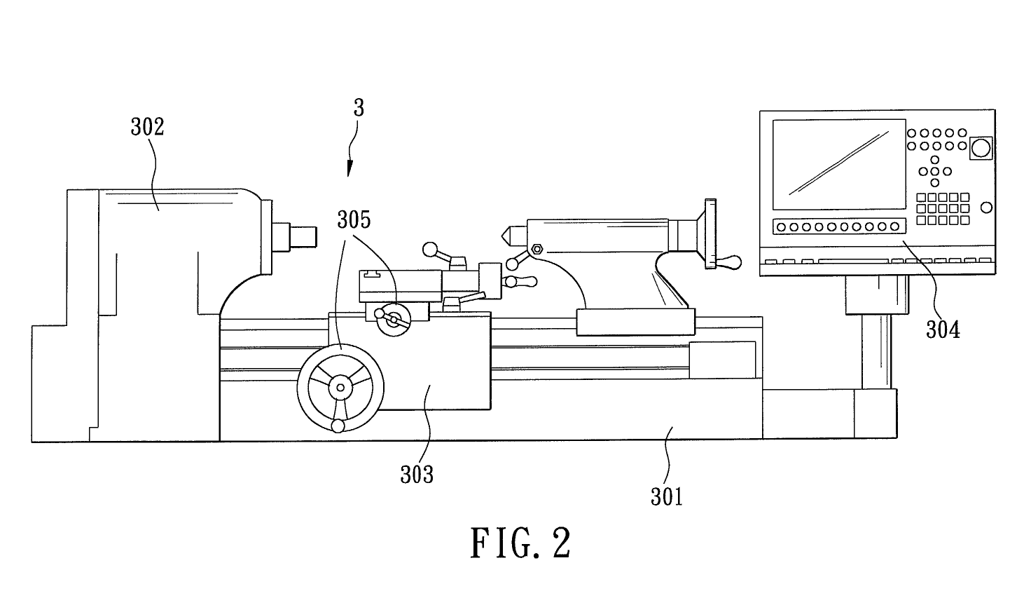

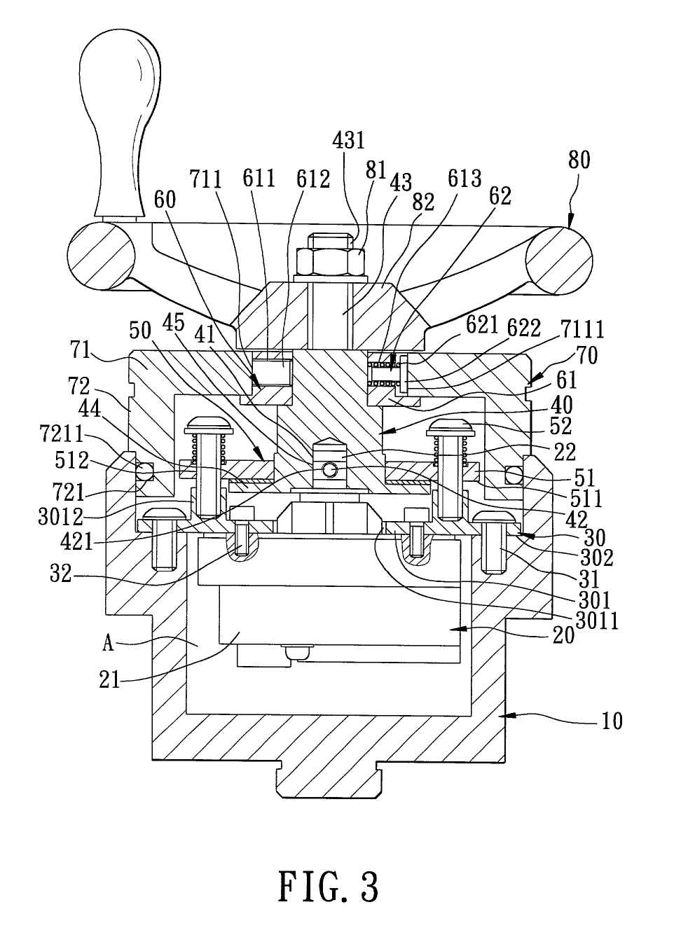

Referring to FIG. 2, the first preferred embodiment of a hand wheel 305 according to the present invention is shown to be installed on a learning-type lathe 3. The learning-type lathe 3 comprises a plane stock 301, a headstock 302 disposed on a left end side of the plane stock 301, a cutter seat 303 disposed movably on an upper side of the plane stock 301, a numeric control machine 304 disposed on a right end side of the plane stock 301, and two hand wheels 305 disposed on a side portion of the cutter seat 303. The cutter seat 303 is movable slidably in a horizontal direction relative to the plane stock 301. The numeric control machine 304 is used to control automated operation of the learning-type lathe 3. The hand wheels 305 permit manual control of the advancing and retreating movements of the cutter seat 303. As shown in FIG. 3, each of the hand wheels 305 comprises a hollow support base 10, an encoding device 20, a coupling shaft 40, a resistance unit 50, a hollow indicia member 70, a friction coupling unit 60, and a wheel member 80. The hollow support base 10 confines a receiving space (A) with an open end and has a wire hole (not visible) formed therein.

The encoding device 20 is disposed in the receiving space (A), has a seat portion 21 and a rotary spindle 22, and generates an electrical signal output that corresponds to detected rotation of the spindle 22 relative to the seat portion 21. The seat portion 21 is mounted to the support base 10, and has a conductor unit (not shown) extending through the wire hole of the support base 10 and connected to a motor drive unit (not shown) of the plane stock 301. The drive unit (not shown) controls the movement of the cutter seat 303. The rotary spindle 22 is mounted rotatably on and extends from the seat portion 21 toward the open end of the receiving space (A).

The coupling shaft 40 has a first end 41, and an opposite second end 43. The first end 41 is formed with a radial outward flange 44 and a blind hole 45. The blind hole 45 is used for receiving the spindle 22 of the encoding device 20. A fastener unit 42 includes a number of screws 421 (only one is shown) that extend radially into the coupling shaft 40 to engage the spindle 22 and to couple the coupling shaft 40 to the spindle 22 such that the spindle 22 is co-rotatable with the coupling shaft 40. The opposite second end 43 extends outwardly from the open end of the receiving space (A) and has an externally threaded end 431.

The resistance unit 50 serves to resist rotation of the coupling shaft 40 relative to the support base 10, and includes a brake disk 51, an anchor plate 30, and a plurality of spring-loaded fasteners 52. The brake disk 51 is sleeved on the coupling shaft 40, and has a braking surface 511 superimposed on and in friction contact with the radial outward flange 44, and four fastener holes 512 (only two are visible). The anchor plate 30 has a disc-shaped body with a central portion 301 and a peripheral portion 302 connected to the central portion 301. The central portion 301 is mounted with the seat portion 21 of the encoding device 20 by means of screws 32, and is formed with a spindle hole 3011 for extension of the spindle 22 therethrough, and a plurality of screw sockets 3012. The peripheral portion 302 is mounted on the support base 10 by means of screws 31, thereby closing the receiving space (A) of the support base 10. Each of the spring-loaded fasteners 52 extends through the fastener holes 512 in the brake disk 51, and engages one of the screw sockets 3012 in the central portion 301. The fasteners 52 urge the brake disk 51 toward the radial outward flange 44.

The indicia member 70 is sleeved on the coupling shaft 40 between the first and second ends 41, 43, is used to indicate angular rotation of the coupling shaft 40 relative to the support base 10, and includes a plate section 71 and an annular wall section 72. The plate section 71 is formed with a shaft hole 711. The annular wall section 72 extends from a periphery of the plate section 71 toward the open end of the support base 10, and is formed with a peripheral groove 721. The peripheral groove 721 is disposed adjacent to the support base 10, and has a plurality of steel balls 7211 received therein. The steel balls 7211 abut against the support base 10 and ensure smooth rotation of the indicia member 70 relative to the support base 10.

The friction coupling unit 60 includes an annular disc 61, a fastener 612, and a spring-loaded stop 62. The annular disc 61 is disposed in the shaft hole 711 around the coupling shaft 40, and is formed with a first radial hole 611 and a second radial hole 613. The fastener 612 is disposed threadedly in the first radial hole 611, and abuts against the coupling shaft 40 so as to retain the annular disc 61 on the coupling shaft 40 and to permit co-rotation of the indicia member 70 with the coupling shaft 40. The spring-loaded stop 62 permits forced rotation of the indicia member 70 relative to the coupling shaft 40, and includes a spring 621 and a curved stop plate 622. The spring 621 is disposed in the second radial hole 613, and abuts against the stop plate 622. The stop plate 622 abuts further against the plate section 71 at a hole-defining wall 7111 of the shaft hole 711.

The wheel member 80 has a hub portion 82, and is operable for driving rotation of the coupling shaft 40. The hub portion 82 has a lower section abutting against the plate section 71 of the indicia member 70. A nut 81 engages threadedly the second end 43 of the coupling shaft 40 so as to secure the hub portion 82 on the plate section 71 of the indicia member 70.

In use, the hand wheels 80 are manually rotated in order to control the cutting of a first work piece in a desired manner to comply with a predetermined specification. Particularly, as the hand wheels 80 are rotated, the encoding device 20 sends an electrical signal output to the motor drive unit (not shown), thereby permitting the latter to control the advancing and retreating movements of the cutter seat 303. The numeric control machine 304 analyzes and memorizes the movements of the cutter seat 303 in connection with the processing of the first work piece. As such, the machine 304 will be able to control the processing of subsequent work pieces without further manual involvement. This saves manpower, and less production hours are needed to process the work pieces with high accuracy. To return the indicia member 70 to a zero position, one hand of the operator grips the wheel member 80, while the other hand grips and forcibly rotates the indicia member 70, thereby overcoming the frictional resistance between the friction coupling unit 60 and the indicia member 70. The resistance unit 50 prevents undesired movement of the wheel members 80. Tightening and loosening of the wheel members 80 can be performed by adjusting the force of the spring-loaded fasteners 52.

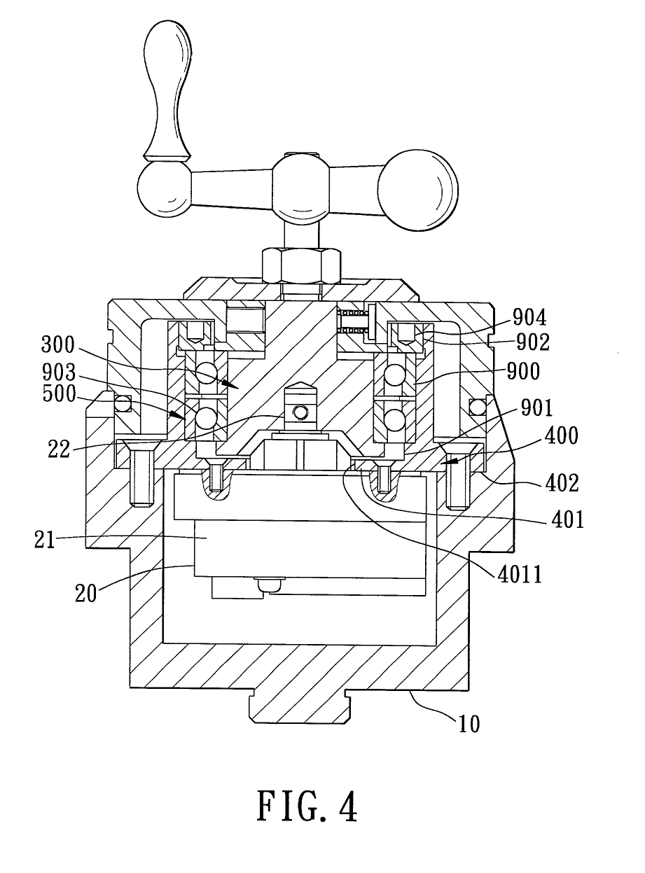

Referring to FIG. 4, the second preferred embodiment of a hand wheel according to the present invention is shown to be substantially similar to the first preferred embodiment. Unlike the previous embodiment, the resistance unit 500 includes an anchor plate 400, a tubular bearing-confining wall 900, and a bearing unit 903. The anchor plate 400 has a central portion 401 and a peripheral portion 402. The central portion 401 is mounted with the seat portion 21 of the encoding device 20, and is formed with a spindle hole 4011 for extension of the spindle 22 therethrough. The peripheral portion 402 is connected to the central portion 401, and is mounted on the support base 10. The tubular bearing-confining wall 900 is disposed to surround the coupling shaft 300, and has a first end 901 and an opposite second end 902. The first end 901 is connected to the anchor plate 400. The bearing unit 903 is disposed between the bearing-confining wall 900 and the coupling shaft 300. The second end 902 is formed with a press unit 904 for pressing the bearing unit 903 toward the anchor plate 400.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A hand wheel comprising:
a hollow support base confining a receiving space with an open end;
an encoding device disposed in said receiving space, and having a seat portion mounted to said support base, and a rotary spindle mounted rotatably on and extending from said seat portion toward said open end of said receiving space, said encoding device generating an electrical signal output that corresponds to detected rotation of said spindle relative to said seat portion;
a coupling shaft having a first end connected to said spindle such that said spindle is co-rotatable with said coupling shaft, and an opposite second end extending outwardly from said open end of said receiving space;
an indicia member sleeved on said coupling shaft between said first and second ends for indicating angular rotation of said coupling shaft relative to said support base;
a friction coupling unit disposed between said coupling shaft and said indicia member to permit co-rotation of said indicia member with said coupling shaft and to permit forced rotation of said indicia member relative to said coupling shaft; and
a wheel member having a hub portion connected to said second end of said coupling shaft and operable for driving rotation of said coupling shaft.

2. The hand wheel as claimed in claim 1, further comprising a resistance unit for resisting rotation of said coupling shaft relative to said support base.

3. The hand wheel as claimed in claim 2, wherein:
said first end of said coupling shaft is formed with a radial outward flange;
said resistance unit including
a brake disk sleeved on said coupling shaft and having a braking surface superimposed on and in friction contact with said radial outward flange,
an anchor plate having a central portion mounted with said seat portion of said encoding device and formed with a spindle hole for extension of said spindle therethrough, and a peripheral portion around said central portion and mounted on said support base, and
a plurality of spring-loaded fasteners extending through said brake disk and connected to said anchor plate, said fasteners urging said brake disk toward said radial outward flange.

4. The hand wheel as claimed in claim 2, wherein said resistance unit includes:
an anchor plate having a central portion mounted with said seat portion of said encoding device and formed with a spindle hole for extension of said spindle therethrough, and a peripheral portion around said central portion and mounted on said support base;
a tubular bearing-confining wall disposed to surround said coupling shaft, and having a first end connected to said anchor plate and an opposite second end; and
a bearing unit disposed between said bearing-confining wall and said coupling shaft;
said second end of said bearing-confining wall being formed with a press unit for pressing said bearing unit toward said anchor plate.

5. The hand wheel as claimed in claim 1, wherein said first end of said coupling shaft is formed with a blind hole for receiving said spindle of said encoding device, said hand wheel further comprising a fastener unit that extends radially into said coupling shaft to engage said spindle for coupling said coupling shaft to said spindle.

6. The hand wheel as claimed in claim 1, wherein said indicia member includes a plate section and an annular wall section that extends from a periphery of said plate section and that is coupled rotatably to said support base.

7. The hand wheel as claimed in claim 6, wherein said annular wall section is formed with a peripheral groove that is disposed adjacent to said support base and that has a plurality of balls received therein.

8. The hand wheel as claimed in claim 6, wherein said plate section is formed with a shaft hole, and said friction coupling unit is disposed in said shaft hole around said coupling shaft.

9. The hand wheel as claimed in claim 8, wherein said friction coupling unit includes:
an annular disc formed with a first radial hole and a second radial hole;
a fastener disposed threadedly in said first radial hole and abutting against said coupling shaft for retaining said annular disc on said coupling shaft; and
a spring-loaded stop disposed in said second radial hole and extending to abut against said plate section at a hole-defining wall of said shaft hole.
